(19) United States
(12) Patent Application Publication
(10) Pub. No.: US 2015/0166400 A1
(43) Pub. Date: Jun. 18, 2015

(54) GLASS AND CHEMICAL STRENGTHENED GLASS

(71) Applicant: ASAHI GLASS COMPANY, LIMITED, Tokyo (JP)

(72) Inventor: Hiroyuki YAMAMOTO, Shizuoka-ken (JP)

(73) Assignee: ASAHI GLASS COMPANY, LIMITED, Tokyo (JP)

(21) Appl. No.: 14/631,400

(22) Filed: Feb. 25, 2015

Related U.S. Application Data
(63) Continuation of application No. PCT/JP2013/074578, filed on Sep. 11, 2013.

(30) Foreign Application Priority Data
Sep. 14, 2012 (JP) 2012-202727

(51) Int. Cl. C03C 3/085; C03C 3/087; C03C 21/00

(52) U.S. Cl. CPC C03C 3/085; C03C 21/002; C03C 3/087

(57) ABSTRACT

There are provided a glass and a chemical strengthened glass having characteristics preferred for an exterior member or decoration of an electronic device, that is, suppressed change in reflected color tone due to difference of light source and excellent mechanical strength. A glass contains a coloring component, having an absolute value of a difference Δa* between chromaticity a* of reflected light by a D65 light source and chromaticity a* of reflected light by an F2 light source in an L*a*b* color system expressed by a following expression (1) of 2.0 or less.

Δa*=a*value(D65 light source)−a*value(F2 light source) (1)

### CROSS-REFERENCE TO RELATED APPLICATIONS

This application is a continuation of prior International Application No. PCT/JP2013/074578 filed on Sep. 11, 2013, which is based upon and claims the benefit of priority from Japanese Patent Application No. 2012-202727 filed on Sep. 14, 2012; the entire contents of all of which are incorporated herein by reference.

### FIELD

The present invention relates to a glass and a chemical strengthened glass used for an exterior member or decoration of an electronic device such as, for example, a communication device or an information device which is portably usable. In this specification, the “chemical strengthened glass” refers to a glass subjected to chemical strengthening, which has a compressive stress layer formed on its surface by the chemical strengthening.

### BACKGROUND

As an exterior member or decoration of an electronic device such as a mobile phone, an appropriate material is used by being selected from among materials such as resin and metal in consideration of various factors such as decorativeness, scratch resistance, workability, and cost.

In recent years, it has been attempted to use, as a material for exterior member, a glass that has not been used hitherto. According to this attempt, by forming the exterior member itself of a glass in an electronic device such as a mobile phone, it is possible to exhibit a unique decorative effect with transparency.

### SUMMARY

The exterior member or decoration of the electronic device is required to provide various design expressions reflecting wide varieties in preferences of consumers. Among the design expressions, the color tone is one of the particularly important matters. Glass used for the exterior member of the electronic device is required to faithfully reproduce the color tone based on the data obtained through marketing activities or the color tone decided by the designer.

The glass containing a coloring component, which has a brightness L* (in an L*a*b* color system standardized by Commission Internationale de l′Éclairage (CIE)) is 20 or more, does not completely shut off the light having the wavelength in the visible range but transmits a certain amount of the light having the wavelength in the visible range, and therefore it is important to set the color tone in consideration of the reflected color tone.

However, the present inventor has found that when the glass containing the coloring component is used for the exterior member of a portable electronic device used in various places such as outdoors and indoors, the reflected color tone of the glass is different between outdoors and indoors depending on the contained coloring component. The change in the reflected color tone due to the difference of the light source is called metamerism. Suppressing the metamerism in the glass containing the coloring component is a new problem found by the present inventor.

It is an object of the present invention to provide a glass and a chemical strengthened glass having characteristics preferred for an exterior member or decoration of an electronic device, that is, suppressed change in reflected color tone due to difference of light source and excellent mechanical strength.

The present inventor has found, after various studies, that a fixed amount of a predetermined component contained in glass can suppress the change in the reflected color tone (hereinafter, sometimes called metamerism) when the light source is different. More specifically, a glass of the present invention is a glass containing a coloring component, having an absolute value of a difference Δa* between chromaticity a* of reflected light by a D65 light source and chromaticity a* of reflected light by an F2 light source in an L*a*b* color system expressed by a following expression (1) of 2.0 or less.

Δa*=a*value(D65 light source)−a*value(F2 light source) (1)

Further, a glass of the present invention is a glass containing a coloring component, having both of an absolute value of a difference Δa* between chromaticity a* of reflected light by a D65 light source and chromaticity a* of reflected light by an F2 light source in an L*a*b* color system expressed by a following expression (1) and an absolute value of a difference Δb* between chromaticity b* of the reflected light by the D65 light source and chromaticity b* of the reflected light by the F2 light source in the L*a*b* color system expressed by a following expression (2), of 2.0 or less.

Δa*=a*value(D65 light source)−a*value(F2 light source) (1)

Δb*=b*value(D65 light source)−b*value(F2 light source) (2)

A chemical strengthened glass of the present invention is a glass containing a coloring component, having an absolute value of a difference Δa* between chromaticity a* of reflected light by a D65 light source and chromaticity a* of reflected light by an F2 light source in an L*a*b* color system expressed by a following expression (1) of 2.0 or less, and including a surface compressive stress layer of 5 μm to 70 μm in a depth direction from a surface.

Δa*=a*value(D65 light source)−a*value(F2 light source) (1)

Further, a chemical strengthened glass of the present invention is a glass containing a coloring component, having both of an absolute value of a difference Δa* between chromaticity a* of reflected light by a D65 light source and chromaticity a* of reflected light by an F2 light source in an L*a*b* color system expressed by a following expression (1) and an absolute value of a difference Δb* between chromaticity b* of the reflected light by the D65 light source and chromaticity b* of the reflected light by the F2 light source in the L*a*b* color system expressed by a following expression (2), of 2.0 or less, and including a surface compressive stress layer of 5 μm to 70 μm in a depth direction from a surface.

Δa*=a*value(D65 light source)−a*value(F2 light source) (1)

Δb*=b*value(D65 light source)−b*value(F2 light source) (2)

According to the present invention, a glass having suppressed change in reflected color tone due to difference of light source can be obtained. Further, a chemical strengthened glass having excellent mechanical strength can be obtained.

### DETAILED DESCRIPTION

The metamerism is an index indicating the degree of a color change of a color tone or an outer color due to color of outside light and can be defined by using the L*a*b* color system standardized by CIE (Commission Internationale de l′Éclairage). The lower the metamerism is, the smaller the degree of the color change of the color tone or the outer color due to the color of the outside light becomes. When the metamerism of the glass is high, if the kind of the light source is different, the visual effect of the color tone of the glass becomes greatly different. For example, the color tone of the glass indoors and the color tone of the glass outdoors differ greatly.

The glass and the chemical strengthened glass of the present invention contain a coloring component, and have an absolute value of Δa* defined by the following expression (1) of 2.0 or less. This can reduce the difference between a reflected color tone of the glass indoors and a reflected color tone of the glass outdoors.

Δa* represents a difference between chromaticity a* of reflected light by a D65 light source and chromaticity a* of reflected light by an F2 light source in the L*a*b* color system.

Δa*=a*value(D65 light source)−a*value(F2 light source) (1)

The glass and the chemical strengthened glass of the present invention contain a coloring component, and have an absolute value of Δa* defined by the following expression (1) and an absolute value of Δb* defined by the following expression (2) of 2.0 or less. This can reduce the difference between a reflected color tone of the glass indoors and a reflected color tone of the glass outdoors.

Δa* represents a difference between chromaticity a* of reflected light by a D65 light source and chromaticity a* of reflected light by an F2 light source in the L*a*b* color system.

Δa*=a*value(D65 light source)−a*value(F2 light source) (1)

Δb* represents a difference between chromaticity b* of the reflected light by the D65 light source and chromaticity b* of the reflected light by the F2 light source in the L*a*b* color system.

Δb*=b*value(D65 light source)−b*value(F2 light source) (2)

Note that the glass before chemical strengthening and having metamerism suppressed exhibits the similar tendency (suppressed metamerism) also after the chemical strengthening.

In the L*a*b* color system, a* indicates a color tone change from red to green, and b* indicates a color tone change from yellow to blue. What color tone change human being more sensitively feels is a color tone change from red to green. The glass and the chemical strengthened glass of the present invention can achieve a glass having metamerism suppressed by making an absolute value of Δa* to 2.0 or less. Further, a glass having metamerism further suppressed can be obtained by making both of absolute values of Δa* and Δb* to 2.0 or less.

The glass and the chemical strengthened glass of the present invention preferably have a brightness L* defined using the L*a*b* color system falling within a range of 20 to 85. More specifically, when L* falls within the aforementioned range, the brightness of the glass is in an intermediate region between “bright” and “dark” and is therefore a in range which is easily recognized with respect to the color change, for which the present invention is more effectively used. Note that when L* is less than 20, the glass exhibits a deep color so that the color tone change of the glass is difficult to recognize. On the other hand, when L* exceeds 85, the glass exhibits a light color so that the color tone change of the glass is difficult to recognize. L* is preferably 20 to 60, more preferably 22 to 50, even more preferably 23 to 40, and particularly preferably 24 to 30. The aforementioned brightness L* is based on data obtained by measuring reflected light in the case of using an F2 light source and installing a white resin plate on the rear face side of the glass.

The glass and the chemical strengthened glass of the present invention preferably contain in the glass, as the coloring component, a total amount of at least one component selected from a group consisting of Fe₂O₃, CuO, V₂O₅ and Se of 0.001% to 5% expressed in mole percentage based on oxides. Thus, a glass with desired coloring and having suppressed metamerism can be obtained.

The reason why the metamerism is suppressed by containing at least one component selected from a group consisting of Fe₂O₃, CuO, V₂O₅ and Se as the coloring component in the glass is guessed as follows.

The reflected color tone of the glass is made by overlap of the spectral distribution of the light source and the spectral reflectance of the glass.

The spectral distribution of the light source is different depending on the kind of the light source. The D65 light source is a light source for measuring an object color irradiated with daylight including an ultraviolet region and exhibits a broad spectral distribution in the visible wavelength region. On the other hand, the F2 light source is white light of a representative fluorescent lamp and exhibits a spectral distribution having a peak at a specific wavelength in the visible wavelength region.

Each of the coloring components contained in the glass is different in wavelength to absorb. Therefore, the spectral reflectance of the glass containing the coloring component differs depending on the kind and content of the coloring component.

The glass containing at least one component selected from a group consisting of Fe₂O₃, CuO, V₂O₅ and Se has a small difference between a reflected color tone of the glass in the case of using the D65 light source and a reflected color tone of the glass in the case of using the F2 light source. This is considered to be because the glass containing the above coloring component has a characteristic of absorbing light of a wavelength having a peak in the spectral distribution of the F2 light source and thereby lessens the difference in spectral distribution due to the light source, resulting in the small difference in the reflected color tone of the glass.

When containing, as the coloring component, at least one component selected from a group consisting of Fe₂O₃, CuO, V₂O₅ and Se, the glass preferably contains 0.001% to 5% of them expressed in mole percentage based on oxides. When the coloring components are contained, if the total amount of the coloring components is less than 0.001%, it is possible that a significant effect cannot be obtained regarding suppression of the metamerism. Preferably, its content is 0.01% or more, more preferably, 0.05% or more, even more preferably 0.1% or more, typically 0.2% or more. When the total amount of the coloring components is more than 5%, the glass becomes unstable and devitrification may occur. It is preferably 4.5% or less, typically 4% or less. One kind or two or more kinds of the coloring components may be contained.

When Fe₂O₃ is contained as the coloring component, if its content is less than 0.015%, it is possible that a significant effect cannot be obtained regarding suppression of the metamerism. Preferably, its content is 0.05% or more, more preferably, 0.1% or more, typically 0.2% or more. When the content of Fe₂O₃ is more than 5%, the glass becomes unstable and devitrification may occur. Its content is preferably 4% or less, typically 3% or less.

When CuO is contained as the coloring component, if its content is less than 0.01%, it is possible that a significant effect cannot be obtained regarding suppression of the metamerism. Preferably, its content is 0.05% or more, more preferably, 0.1% or more, typically 0.2% or more. When the content of CuO is more than 5%, the glass becomes unstable and devitrification may occur. Its content is preferably 4% or less, typically 3% or less.

When V₂O₅ is contained as the coloring component, if its content is less than 0.01%, it is possible that a significant effect cannot be obtained regarding suppression of the metamerism. Preferably, its content is 0.05% or more, more preferably, 0.1% or more, typically 0.2% or more. When the content of V₂O₅ is more than 5%, the glass becomes unstable and devitrification may occur. Its content is preferably 4% or less, typically 3% or less.

When Se is contained as the coloring component, if its content is less than 0.001%, it is possible that a significant effect cannot be obtained regarding suppression of the metamerism. Preferably, its content is 0.005% or more, more preferably, 0.01% or more, typically 0.1% or more. When the content of Se is more than 5%, the glass becomes unstable and devitrification may occur. Its content is preferably 4% or less, typically 3% or less.

Next, a preferred glass composition (except Fe₂O₃, CuO, V₂O₅, and Se) of the glass of the present invention will be described.

An example of the glass of the present invention includes the one containing, expressed in mole percentage based on following oxides, 55% to 80% of SiO₂, 0.25% to 16% of Al₂O₃, 0% to 12% of B₂O₃, 5% to 20% of Na₂O, 0% to 15% of K₂O, 0% to 15% of MgO, 0% to 15% of CaO, 0% to 25% of ΣRO (R represents Mg, Ca, Sr, Ba, Zn), 0% to 1% of ZrO₂, 0% to 5% of Fe₂O₃, 0% to 5% of CuO, 0% to 5% of V₂O₅, 0% to 5% of Se, and 0.001% to 5% of Fe₂O₃+CuO+V₂O₅+Se.

Hereinafter, a composition of a glass of the present invention will be described using a content expressed in mole percentage based on oxides unless otherwise stated. Note that in this specification, the content of each component of the glass and a coloring component indicates a converted content given that each component existing in the glass exists as the expressed represented oxide.

For example, “containing 0.01% to 5% of Fe₂O₃” means a Fe content given that Fe existing in the glass exists entirely in the form of Fe₂O₃, that is, the Fe₂O₃-converted content of Fe is 0.01% to 5%.

SiO₂ is a network former component of the glass and hence is essential. When its content is less than 55%, stability as a glass decreases, or weather resistance decreases. Preferably, its content is 60% or more. More preferably, its content is 65% or more. When the content of SiO₂ is more than 80%, viscosity of the glass increases, and meltability decreases significantly. Preferably, its content is 75% or less, typically 70% or less.

Al₂O₃ is a component improving weather resistance and chemical strengthening characteristic of the glass and is essential. When its content is less than 0.25%, the weather resistance decreases. Preferably, its content is 0.5% or more, typically 1% or more.

When the content of Al₂O₃ is more than 16%, viscosity of the glass becomes high and uniform melting becomes difficult. Preferably, its content is 14% or less, typically 12% or less.
When a high surface compressive stress is formed on the surface of the glass by chemical strengthening, the content of Al₂O₃ is preferably 5% to 16% (though not including 5%). Further, when the glass is increased in meltability and manufactured at low cost, the content of Al₂O₃ is preferably 0.25% to 5%.

B₂O₃ is a component improving weather resistance of the glass, and is not essential but can be contained as necessary. When B₂O₃ is contained, if its content is less than 4%, it is possible that a significant effect cannot be obtained regarding improvement of the weather resistance. Preferably, its content is 5% or more, typically 6% or more. When the content of B₂O₃ is more than 12%, it is possible that striae due to volatilization occur and the yield decreases. Preferably, its content is 11% or less, typically 10% or less.

Na₂O is a component improving meltability of the glass, and is essential because it causes a surface compressive stress layer to be formed by ion exchange. When its content is less than 5%, the meltability is poor and it is also difficult to form a desired surface compressive stress layer by ion exchange. Preferably, its content is 6% or more, typically 7% or more.

The weather resistance decreases when the content of Na₂O is more than 20%. Preferably, its content is 18%% or less, typically 16% or less.

K₂O is a component improving meltability of the glass, and having an operation to increase ion exchange speed in chemical strengthening. Thus, it is not essential but is preferred to be contained. When K₂O is contained, if its content is less than 0.01%, it is possible that a significant effect cannot be obtained regarding improvement of meltability or that a significant effect cannot be obtained regarding ion exchange speed improvement. Typically, its content is 0.3% or more. When the content of K₂O is more than 15%, weather resistance decreases. Preferably, its content is 13% or less, typically 10% or less.

RO (R represents Mg, Ca, Sr, Ba, Zn) is a component for improving meltability of the glass and is not essential, but any one or more of them can be contained as necessary. In this case, it is possible that the meltability decreases when the total content ΣRO (ΣRO represents MgO+CaO+SrO+BaO+ZnO) of RO is less than 1%. Preferably, its content is 3% or more, typically 5% or more. When the content of ΣRO is more than 25%, weather resistance decreases. Preferably, its content is 20% or less, more preferably 18% or less, typically 15% or less.

MgO is a component improving meltability of the glass, and is not essential but can be contained as necessary. When MgO is contained, if its content is less than 3%, it is possible that a significant effect cannot be obtained regarding improvement of meltability. Typically, its content is 4% or more. When the content of MgO is more than 15%, weather resistance decreases. Preferably, its content is 13% or less, typically 12% or less.

CaO is a component improving meltability of the glass and is not essential but can be contained as necessary. When CaO is contained, if its content is less than 0.01%, a significant effect cannot be obtained regarding improvement of meltability. Typically, its content is 0.1% or more. When the content of CaO is more than 15%, the chemical strengthening characteristic decreases. Preferably, its content is 12% or less, typically 10% or less. Further, when the chemical strengthening characteristic of the glass is increased, it is preferably not contained practically.

When a high surface compressive stress is formed on the surface of the glass by chemical strengthening, the content of CaO is preferably 0% to 5% (though not including 5%). Further, when the glass is increased in meltability and manufactured at low cost, the content of CaO is preferably 5% to 15%.

SrO is a component for improving meltability, and is not essential but can be contained as necessary. When SrO is contained, if its content is less than 1%, it is possible that a significant effect cannot be obtained regarding improvement of meltability. Preferably, its content is 3% or more, typically 6% or more. When the content of SrO is more than 15%, it is possible that weather resistance and chemical strengthening characteristic decrease. Preferably, its content is 12% or less, typically 9% or less.

BaO is a component for improving meltability, and is not essential but can be contained as necessary. When BaO is contained, if its content is less than 1%, it is possible that a significant effect cannot be obtained regarding improvement of meltability. Preferably, its content is 3% or more, typically 6% or more. When the content of BaO is more than 15%, it is possible that weather resistance and chemical strengthening characteristic decrease. Preferably, its content is 12% or less, typically 9% or less.

ZrO₂ is a component increasing ion exchange speed and is not essential, but can be contained as necessary. When ZrO₂ is contained, its content is preferably in a range of 5% or less, more preferably 4% or less, even more preferably 3% or less. When the content of ZrO₂ is more than 5%, meltability worsens and ZrO₂ possibly remains as a non-melted matter in the glass. Typically, ZrO₂ is not contained.

ZnO is a component for improving meltability, and is not essential but can be contained as necessary. When ZnO is contained, if its content is less than 1%, it is possible that a significant effect cannot be obtained regarding improvement of meltability. Preferably, its content is 3% or more, typically 6% or more. When the content of ZnO is more than 15%, it is possible that weather resistance decreases. Preferably, its content is 12% or less, typically 9% or less.

Fe₂O₃ preferably has a ratio of bivalent iron converted into Fe₂O₃ (iron redox) of 10% to 50%, particularly 15% to 40%. Most preferably, the ratio is 20% to 30%. When the iron redox is less than 10%, decomposition of SO₃ does not proceed when it is contained, and it is possible that an expected fining effect cannot be obtained. When the ratio is more than 50%, decomposition of SO₃ proceeds too much before fining, and it is possible that the expected fining effect cannot be obtained, or that it becomes a source of bubbles and increases the number of bubbles.

In this specification, the content of the total iron converted into Fe₂O₃ represents the content of Fe₂O₃. Regarding the iron redox, the ratio of bivalent iron converted into Fe₂O₃ among the total iron converted into Fe₂O₃ by a Moessbauer spectroscopy can be represented by percent. Specifically, evaluation is performed with a transmission optical system in which a radiation source (⁵⁷Co), a glass sample (a glass flat plate having a thickness of 3 mm to 7 mm which is cut from the above-described glass block, ground, and mirror polished), and a detector (45431 made by LND Inc.) are disposed on a straight line. The radiation source is moved with respect to an axial direction of the optical system, so as to cause an energy change of γ ray by a Doppler effect. Then, a Moessbauer absorption spectrum obtained at room temperature is used to calculate the ratio of bivalent iron to the total iron and the ratio of trivalent iron to the total iron, and the ratio of bivalent Fe to the total iron is taken as the iron redox.

In addition to the above components, the following components may be introduced in the glass composition.

Co₃O₄ is a coloring component for coloring a glass with a deep color, and is a component which exhibits a bubble eliminating effect while coexisting with iron. And it is not essential but may be contained in a range of 5% or less. Specifically, O₂ bubbles discharged when trivalent iron becomes bivalent iron in a high-temperature state are absorbed when cobalt is oxidized. Consequently the O₂ bubbles are reduced, and thus the bubble eliminating effect is obtained.

Moreover, Co₃O₄ is a component for further increasing the refining operation when being allowed to coexist with SO₃. Specifically, for example, when a sodium sulfate (Na₂SO₄) is used as a refining agent, bubble elimination from the glass improves by allowing the reaction SO₃→SO₂+½O₂ to proceed, and thus the oxygen partial pressure in the glass is preferred to be low. By co-adding cobalt to a glass containing iron, release of oxygen occurring due to reduction of iron can be suppressed by oxidation of cobalt, and thus decomposition of SO₃ is accelerated. Thus, it is possible to produce a glass with less bubble defects.

Further, in a glass containing a relatively large amount of alkali metal for chemical strengthening, basicity of the glass increases, SO₃ does not decompose easily, and the refining effect decreases. In this manner, in a glass containing iron in which SO₃ does not decompose easily, cobalt accelerates decomposition of SO₃, and hence is effective in particular for acceleration of the bubble eliminating effect.

In order for such a refining operation to occur, the content of Co₃O₄ is 0.01% or more, preferably 0.02% or more, typically 0.03% or more. When its content is more than 5%, the glass becomes unstable and devitrification occurs. Preferably, its content is 4% or less, more preferably 3% or less.

SO₃ is a component operating as a refining agent, and is not essential but can be contained as necessary. When SO₃ is contained, if its content is less than 0.005%, an expected refining operation cannot be obtained. Preferably, its content is 0.01% or more, more preferably 0.02% or more. Most preferably, its content is 0.03% or more. Further, when its content is more than 0.5%, it inversely becomes a source of bubbles, and it is possible that melting down of the glass becomes slow or the number of bubbles increases. Preferably, its content is 0.3% or less, more preferably 0.2% or less. Most preferably, its content is 0.1% or less.

SnO₂ is a component operating as a refining agent, and is not essential but can be contained as necessary. When SnO₂ is contained, if its content is less than 0.005%, an expected refining operation cannot be obtained. Preferably, its content is 0.01% or more, more preferably 0.05% or more. Further, when its content is more than 1%, it inversely becomes a source of bubbles, and it is possible that melting down of the glass becomes slow or the number of bubbles increases. Preferably, its content is 0.8% or less, more preferably 0.5% or less. Most preferably, its content is 0.3% or less.

As the refining agent when melting the glass, chloride, fluoride and the like may be contained as necessary in addition to above-described SO₃, SnO₂.

Li₂O is a component for improving meltability, and is not essential but can be contained as necessary. When Li₂O is contained, if its content is less than 1%, it is possible that a significant effect cannot be obtained regarding improvement of meltability. Preferably, its content is 3% or more, typically 6% or more. When the content of Li₂O is more than 15%, it is possible that weather resistance decreases. Preferably, its content is 10% or less, typically 5% or less.

As the coloring component, MpOq (where M represents at least one kind selected from among Ti, Cr, Pr, Ce, Bi, Eu, Mn, Er, Ni, Nd, W, Rb and Ag, and p and q are atomic ratios of M and O) can be contained as necessary. The coloring components are components for coloring a glass with a desired color. Appropriately selecting coloring components makes it possible to obtain a glass colored in, for example, blue, green, yellow, purple, pink, red, achromatic color or the like.

When the above-described content of the coloring component of MpOq is less than 0.001%, coloring of the glass is too pale. Thus, unless the glass is made thick, the glass cannot be recognized to be colored, and there arises a need to design the glass to have a considerable thickness for a design. Accordingly, its content is contained 0.001% or more. Preferably, its content is 0.05% or more, more preferably 0.1% or more. When its content is more than 10%, the glass becomes unstable and devitrification occurs. Accordingly, its content is 10% or less. Preferably, its content is 8% or less, more preferably 5% or less.

The glass and the chemical strengthened glass of the present invention may have a surface compressive stress layer on the surface of the glass. Thus, a colored glass having a high mechanical strength can be obtained. It is preferable that the strengthening is performed so that the depth of the surface compressive stress layer (hereinafter, sometimes referred to as DOL) formed on the surface of the glass is 5 μm or more, 10 μm or more, 20 μm or more, 30 μm or more. In the case of using the glass for an exterior member, the surface of the glass may be highly possibly scratched to decrease the mechanical strength of the glass. Hence, increasing the DOL makes the chemical strengthened glass difficult to break even if its surface is scratched. On the other hand, to make the glass after being strengthened easy to cut, the DOL is preferably 70 μm or less.

It is preferred that the glass and the chemical strengthened glass of the present invention have been chemically strengthened so that the surface compressive stress (hereinafter, sometimes referred to as CS) formed on the glass surface is 300 MPa or more, 500 MPa or more, 700 MPa or more, 900 MPa or more. An increase in CS increases the mechanical strength of the chemical strengthened glass. On the other hand, when the CS is too high, it is possible that the central tension stress inside the glass becomes extremely high, and therefore the CS is preferably 1400 MPa or less, more preferably 1300 MPa or less.

As a method to increase strength of the glass, a method of forming a compressive stress layer on a glass surface is generally known. Representative methods to form the compressive stress layer on a glass surface are an air-cooling tempering method (physical tempering method) and a chemical strengthening method. The air-cooling tempering method (physical tempering method) is a method of rapidly cooling by air cooling or the like a glass plate surface heated to a temperature near a softening point. On the other hand, the chemical strengthening method is a method of replacing alkali metal ions (typically, Li ions, Na ions) having a smaller ion radius existing on the glass plate surface with alkali ions (typically, Na ions or K ions for Li ions, or K ions for Na ions) having a larger ion radius by ion exchange at temperatures lower than or equal to a glass transition point.

For example, in general, the glass used for an exterior member of an electronic device is often used with a thickness of 2 mm or less. When the air-cooling tempering method is employed for such a thin glass plate, it is difficult to assure a temperature difference between the surface and the inside, and hence it is difficult to form the compressive stress layer. Thus, in the glass after being strengthened, the intended high strength characteristic cannot be obtained. Further, in the air-cooling tempering, due to variation in cooling temperature, there is a great concern that the flatness of the glass plate is impaired. The concern that the flatness is impaired is large in a thin glass plate in particular, and there is a possibility of impairing texture aimed by the present invention. From these points, it is preferred that the glass is strengthened by the latter chemical strengthening method.

The chemical strengthening can be performed, for example, by immersing a glass in a molten salt at 400° C. to 550° C. for about 1 hour to about 20 hours. The molten salt used for the chemical strengthening is not particularly limited as long as it contains potassium ions or sodium ions and, for example, a molten salt of potassium nitrate (KNO₃) is preferably used. Besides, a molten salt of sodium nitrate (NaNO₃), or a molten salt made by mixing potassium nitrate (KNO₃) and sodium nitrate (NaNO₃) may be used.

The glass and the chemical strengthened glass of the present invention may be, as a glass, a so-called phase-separated glass or crystallized glass in which phase separation or crystallization occurs in the glass. In the case of using the glass for an exterior member, a so-called shielding property (opacity) of preventing the rear side from being seen through from the front side is sometimes required. A means for giving the glass the shielding property is a method of making the glass in a deep color using a coloring component to decrease the reflection/transmission factor of the visible light. There is another method of causing phase separation or crystallization in the glass to diffuse light transmitted through the glass by these microstructures in the glass so as to decrease the reflection/transmission factor. As for the glass and the chemical strengthened glass of the present invention, a glass with a high shielding property and a desired color tone can be obtained by using the phase-separated glass or crystallized glass containing a coloring component. Further, by performing the above-described chemical strengthening on the phase-separated glass or crystallized glass, a chemical strengthened glass with a high mechanical strength can be obtained.

In the crystallized glass, a crystal phase having a size of several nanometers to several micrometers is distributed in a glass matrix, and the kind and size of crystal to precipitate can be changed by selecting the composition of a base glass and controlling the manufacturing condition and thermal treatment condition, resulting in a glass with a desired shielding property.

In the phase-separated glass, two or more glass phases different in composition are distributed. There are a spinodal one in which two phases are continuously distributed and a binodal one in which one phase is distributed in the form of particles in the matrix, and each phase has a size of 1 μm or less. As the phase-separated glass, a glass with a desired shielding property can be obtained by controlling the composition for achieving an appropriate phase-separation region and under a thermal treatment condition when performing a phase-separation treatment.

It is preferred that the glass and the chemical strengthened glass of the present invention are used as an exterior member. Since the glass is colored and suppressed in metamerism, a high beauty can be given to a device using the exterior member. Besides, the exterior member uses the chemical strengthened glass and thereby can be provided with a high mechanical strength which prevents breakage and scratch due to impact in addition to the above. The exterior member is to be provided, for example, on the outer surface of an electronic device, but is not limited to the electronic device and may be provided on the outer surface of decorations, building material, furniture, automobile control panel and interior part. Further, the glass itself may constitute an article. Further, the shape of the glass is not limited to a flat plate shape, but the glass may have a shape other than the flat plate shape.

As the exterior member, not particularly limited, the glass can be preferably used, for example, for a mobile electronic device that is presumed to be used indoors and outdoors. The mobile electronic device means a concept including a communication device and an information device for mobile use. Examples of the communication device include a mobile phone, a PHS (Personal Handy-phone System), a smartphone, a PDA (Personal Data Assistance), a PND (Portable Navigation Device, a portable car navigation system) as a communication terminal, and include a portable radio, a portable television set, a One-Seg receiver as a broadcast receiver. Further, examples of the information devices include a digital camera, a video camera, a portable music player, a sound recorder, a portable DVD player, a portable game machine, a laptop personal computer, a tablet PC, an electronic dictionary, an electronic notebook, an electronic book reader, a portable printer, a portable scanner, and so on. Further, the exterior member is also usable for a stationary-type electronic device and an electronic device internally mounted on an automobile. Note that the electronic device is not limited to these examples.

The method for manufacturing the glass of the present invention is not particularly limited. For example, appropriate amounts of various glass raw materials are blended, heated and melted, thereafter made uniform by bubble elimination, stirring, or the like, and formed in a plate shape or the like by a known down-draw method, press method, or the like, or casted and formed in a desired shape. Then, the glass is cut into a desired size after slow cooling, and polishing as necessary. Alternatively, the glass once molded into a block shape is reheated and thereby softened, then press-formed into a glass in a desired shape. Further, the chemical strengthened glass of the present invention is made by chemical strengthening the thus-obtained glass. Then, the glass subjected to chemical strengthening is cooled to form into the chemical strengthened glass.

In the foregoing, the glass and the chemical strengthened glass of the present invention have been described using examples, but the structure can be appropriately changed as necessary within a limit that does not go against the spirit of the present invention.

### Examples

Hereinafter, the present invention will be described in detail on the basis of examples of the present invention, but the present invention is not limited only to the examples of the present invention.

Regarding Example 1 to Example 99 of Table 1 to Table 11 (Examples 1 to 43, Examples 47 to 98 are examples of the present invention, and Examples 44 to 46, and 99 are comparative examples), generally used glass raw materials such as oxides, hydroxides, carbonates, nitrates, and the like were appropriately selected and measured to be 100 ml as a glass so that they are in compositions expressed in mole percent in the tables. Note that SO₃ listed in the tables is residual SO₃ remaining in the glass after sodium sulfate (Na₂SO₄) is added to the glass raw materials and the sodium sulfate is decomposed, and is a calculated value.

Next, this material mixture was put into a melting pot made of platinum, placed in a resistance-heating electric furnace at 1500° C. to 1600° C., and after heated for about 0.5 hours and the material was melted down, it was melted for one hour to eliminate bubbles. Thereafter, it was poured into a mold material preheated to approximately 630° C., which is about 50 mm long, about 100 mm wide, and about 20 mm high, and slowly cooled at the rate of about 1° C./min, thereby obtaining a glass block. This glass block was cut, and after the glass was cut out so that it has a size of 40 mm×40 mm and a thickness of 0.8 mm, it was ground and finally mirror polished on both surfaces, thereby obtaining a plate-shaped glass.

For the obtained plate-shaped glass, the color tone before the chemical strengthening was measured. As the color tone of each glass, the chromaticity of reflected light in the L*a*b* color system standardized by CIE was measured. Using an F2 light source and a D65 light source as the light source, the chromaticity of the reflected light was measured for each of them. The chromaticity measurement of the reflected light in the L*a*b* color system was performed using the spectro-colorimeter (Colori7 made by X-Rite, Inc.). Note that on a rear face side (the rear face of a face irradiated with light from the light source) of the glass, a white resin plate was placed to perform measurement.

Regarding the glasses (Example 7, Example, 8, Example 24 to Example 27, Example 29 to Example 39, Example 69, Example 71, Example 75 to Example 78), the surface compressive stress (CS) and the depth of the surface compressive stress layer (DOL) were measured using a surface stress measurement apparatus after chemical strengthening. The surface stress measurement apparatus is an apparatus utilizing the fact that the surface compressive stress layer formed on a glass surface differs in refractive index from other glass portions in which the surface compressive stress layer does not exist, thereby exhibiting an optical waveguide effect. Further, in the surface stress measurement apparatus, an LED whose central wavelength is 795 nm was used as a light source to perform the measurement.

The chemical strengthening was carried out by immersing the glass for 6 hours in a molten salt made of KNO₃ (99%) and NaNO₃ (1%) at 425° C. Further, after the chemical strengthening, the glass was cooled by a process of lowering the temperature of the glass from 425° C. to 300° C. under a cooling condition of 400° C. or more/min.

The above evaluation results are illustrated in Table 1 to Table 11. Note that “-” in Tables indicates items that are not measured.

TABLE 1

| | | mol % | | | | | | | | | |
|---|---|---|---|---|---|---|---|---|---|---|---|
| | | Example | Example | Example | Example | Example | Example | Example | Example | Example | Example |
| | | 1 | 2 | 3 | 4 | 5 | 6 | 7 | 8 | 9 | 10 |
| | SiO₂ | 62.2 | 61.3 | 63.3 | 63.1 | 63.3 | 63.7 | 63.2 | 70.6 | 62.6 | 64.0 |
| | Al₂O₃ | 7.7 | 7.6 | 7.9 | 7.9 | 7.9 | 7.9 | 7.8 | 1.4 | 7.8 | 8.0 |
| | Na₂O | 12.1 | 11.9 | 12.3 | 12.3 | 13.8 | 12.8 | 12.2 | 12.4 | 12.2 | 12.5 |
| | K₂O | 3.9 | 3.8 | 3.9 | 3.9 | 3.9 | 3.9 | 3.9 | 0.2 | 3.9 | 4.0 |
| | CaO | 0 | 0 | 0 | 0 | 0 | 0 | 0 | 8.1 | 0 | 0 |
| | MgO | 10.2 | 10.0 | 10.3 | 10.3 | 8.9 | 9.3 | 10.3 | 5.4 | 10.2 | 10.4 |
| | ZrO₂ | 0.4 | 0.4 | 0.5 | 0.5 | 0.4 | 0.4 | 0.4 | 0 | 0.4 | 0.5 |
| | Fe₂O₃ | 3.4 | 4.8 | 1.6 | 1.9 | 1.0 | 0 | 0 | 0 | 0 | 0 |
| | CuO | 0 | 0 | 0 | 0 | 0 | 0.98 | 0.98 | 0.98 | 1.95 | 0 |
| | Se | 0 | 0 | 0 | 0 | 0 | 0 | 0 | 0 | 0 | 0.5 |
| | NiO | 0 | 0 | 0 | 0 | 0.46 | 0.67 | 0.64 | 0.80 | 0.64 | 0 |
| | Co₃O₄ | 0 | 0 | 0.07 | 0.10 | 0.05 | 0.04 | 0.05 | 0.05 | 0 | 0 |
| | TiO₂ | 0 | 0 | 0 | 0 | 0.25 | 0.25 | 0.24 | 0 | 0.24 | 0 |
| | MnO₂ | 0 | 0 | 0 | 0 | 0 | 0 | 0 | 0 | 0 | 0 |
| | Er₂O₃ | 0 | 0 | 0 | 0 | 0 | 0 | 0 | 0 | 0 | 0 |
| | Cl | 0 | 0 | 0 | 0 | 0 | 0 | 0.2 | 0 | 0 | 0 |
| | SO₃ | 0.1 | 0.1 | 0.1 | 0.1 | 0.1 | 0.1 | 0 | 0.1 | 0.1 | 0.1 |
| | Total | 100.0 | 99.9 | 100.0 | 100.0 | 99.9 | 100.0 | 99.9 | 100.0 | 100.0 | 100.0 |
| | amount | | | | | | | | | | |
| F2 light | L* | 25.55 | 30.24 | 30.6 | 26.12 | 27.16 | 26.33 | 26.41 | 25.64 | 33.04 | 94.72 |
| source | a* | 0.47 | −0.22 | −3.90 | −1.09 | −0.91 | −0.09 | −0.82 | −0.55 | −2.53 | 0.31 |
| | b* | 0.70 | −0.19 | −8.43 | −4.63 | −2.32 | −3.29 | −2.98 | −2.11 | 10.82 | −0.50 |
| D65 light | L* | 25.49 | 30.27 | 30.97 | 26.28 | 27.17 | 26.32 | 26.44 | 25.73 | 32.42 | — |
| source | a* | 0.65 | −0.33 | −3.17 | −0.63 | −0.24 | 0.82 | −0.16 | −0.22 | −3.57 | 0.13 |
| | b* | 0.62 | −0.1 | −7.78 | −4.23 | −2.13 | −3.32 | −2.97 | −2.13 | 9.53 | — |
| D65-F2 | Δa* | 0.18 | −0.11 | 0.73 | 0.46 | 0.67 | 0.91 | 0.66 | 0.33 | −1.04 | −0.18 |
| | Δb* | −0.08 | 0.09 | 0.65 | 0.40 | 0.19 | −0.03 | 0.01 | −0.02 | −1.29 | — |

| | | | | | | | | | | |
|---|---|---|---|---|---|---|---|---|---|---|
| CS(MPa) | — | — | — | — | — | — | 928 | 772 | — | — |
| DOL(μm) | — | — | — | — | — | — | 30.3 | 7.3 | — | — |

TABLE 2

| | | mol % | | | | | | | | |
|---|---|---|---|---|---|---|---|---|---|---|
| | | Example | Example | Example | Example | Example | Example | Example | Example | Example |
| | | 11 | 12 | 13 | 14 | 15 | 16 | 17 | 18 | 19 |
| | SiO₂ | 63.7 | 63.3 | 63.3 | 63.2 | 63.0 | 63.5 | 63.2 | 64.4 | 62.6 |
| | Al₂O₃ | 7.9 | 7.9 | 7.9 | 7.9 | 7.8 | 7.9 | 7.9 | 7.8 | 7.8 |
| | Na₂O | 12.4 | 12.3 | 12.3 | 12.3 | 12.3 | 12.3 | 12.3 | 13.7 | 12.2 |
| | K₂O | 4.0 | 3.9 | 3.9 | 3.9 | 3.9 | 3.9 | 3.9 | 3.9 | 3.9 |
| | CaO | 0 | 0 | 0 | 0 | 0 | 0 | 0 | 0 | 0 |
| | MgO | 10.4 | 10.3 | 10.3 | 10.3 | 10.3 | 10.4 | 10.3 | 7.3 | 10.2 |
| | ZrO₂ | 0.5 | 0.5 | 0.5 | 0.5 | 0.5 | 0.4 | 0.4 | 0.4 | 0.4 |
| | Fe₂O₃ | 0.3 | 1.0 | 1.0 | 1.0 | 1.0 | 0 | 0 | 0 | 0 |
| | CuO | 0 | 0 | 0 | 0 | 0 | 0.49 | 0.98 | 1.47 | 1.95 |
| | Se | 0 | 0 | 0 | 0 | 0 | 0 | 0 | 0 | 0 |
| | NiO | 0.46 | 0.30 | 0.34 | 0.34 | 0.34 | 0.65 | 0.64 | 0.54 | 0.54 |
| | Co₃O₄ | 0.04 | 0.05 | 0.06 | 0.06 | 0.06 | 0.05 | 0.03 | 0.05 | 0.03 |
| | TiO₂ | 0.25 | 0.25 | 0.25 | 0.25 | 0.25 | 0.25 | 0.25 | 0.24 | 0.24 |
| | MnO₂ | 0 | 0 | 0.01 | 0.10 | 0 | 0 | 0 | 0 | 0 |
| | Er₂O₃ | 0 | 0 | 0 | 0 | 0.39 | 0 | 0 | 0 | 0 |
| | Cl | 0 | 0 | 0 | 0 | 0 | 0 | 0 | 0 | 0 |
| | SO₃ | 0.1 | 0.1 | 0.1 | 0.1 | 0.1 | 0.1 | 0.1 | 0.1 | 0.1 |
| | Total | 100.1 | 99.9 | 100.0 | 100.0 | 99.9 | 99.9 | 100.0 | 100.0 | 100.0 |
| | amount | | | | | | | | | |
| F2 light | L* | 29.71 | 29.44 | 28.05 | 28.72 | 29.32 | 26.51 | 28.81 | 25.13 | 27.49 |
| source | a* | −0.98 | −2.84 | −2.46 | −2.63 | −2.77 | −0.40 | −2.05 | 1.40 | −2.87 |
| | b* | −4.07 | −2.83 | −1.19 | −0.88 | −0.28 | −2.81 | 1.52 | −8.90 | 0.94 |
| D65 light | L* | 29.65 | 29.47 | 28.04 | 28.68 | 29.21 | 26.47 | 28.63 | 25.32 | 27.50 |
| source | a* | 0.92 | −2.12 | −1.85 | −2.01 | −2.06 | 0.92 | −1.70 | 2.65 | −3.37 |
| | b* | −4 | −2.55 | −1.11 | −0.83 | −0.41 | −3.02 | 1.06 | −8.18 | 0.89 |
| D65-F2 | Δa* | 1.90 | 0.72 | 0.61 | 0.62 | 0.71 | 1.32 | 0.35 | 1.25 | −0.50 |
| | Δb* | 0.07 | 0.28 | 0.08 | 0.05 | −0.13 | −0.21 | −0.46 | 0.72 | −0.05 |

| | | | | | | | | | |
|---|---|---|---|---|---|---|---|---|---|
| CS(MPa) | — | — | — | — | — | — | — | — | — |
| DOL(μm) | — | — | — | — | — | — | — | — | — |

TABLE 3

| | | mol % | | | | | | | | |
|---|---|---|---|---|---|---|---|---|---|---|
| | | Example | Example | Example | Example | Example | Example | Example | Example | Example |
| | | 20 | 21 | 22 | 23 | 24 | 25 | 26 | 27 | 28 |
| | SiO₂ | 67.1 | 62.8 | 62.7 | 62.9 | 62.8 | 63.0 | 70.4 | 70.3 | 63.4 |
| | B₂O₃ | 0 | 6.8 | 0 | 0 | 0 | 0 | 0 | 0 | 0 |
| | Al₂O₃ | 10.4 | 13.6 | 7.8 | 7.8 | 7.8 | 7.8 | 1.1 | 1.1 | 7.8 |
| | Na₂O | 11.6 | 13.8 | 12.2 | 12.4 | 12.4 | 12.4 | 12.3 | 12.3 | 5.4 |
| | K₂O | 2.2 | 0.5 | 3.9 | 3.9 | 3.9 | 3.9 | 0.2 | 0.2 | 11.3 |
| | CaO | 0.3 | 0.07 | 0 | 0 | 0 | 0 | 8.4 | 8.4 | 0 |
| | MgO | 5.4 | 0.0 | 10.2 | 10.1 | 10.1 | 10.1 | 5.4 | 5.4 | 10.3 |
| | ZrO₂ | 0 | 0 | 0.5 | 0.5 | 0.5 | 0.5 | 0 | 0 | 0 |
| | Fe₂O₃ | 1.8 | 1.8 | 1.9 | 1.9 | 1.9 | 1.8 | 1.8 | 2.0 | 0 |
| | CuO | 0 | 0 | 0 | 0 | 0 | 0 | 0 | 0 | 0.98 |
| | Se | 0.27 | 0.27 | 0.49 | 0.20 | 0.29 | 0.27 | 0.27 | 0.27 | 0 |
| | NiO | 0 | 0 | 0 | 0 | 0 | 0 | 0 | 0 | 0.64 |
| | Co₃O₄ | 0.10 | 0.10 | 0.10 | 0.10 | 0.10 | 0.10 | 0.10 | 0.10 | 0.05 |
| | TiO₂ | 0.60 | 0 | 0 | 0 | 0 | 0 | 0 | 0 | 0 |
| | Cl | 0.2 | 0.2 | 0.2 | 0.2 | 0.2 | 0 | 0 | 0 | 0 |
| | SO₃ | 0 | 0 | 0 | 0 | 0 | 0.1 | 0.1 | 0.1 | 0.1 |
| | Total | 100.0 | 99.9 | 100.0 | 100.0 | 100.0 | 100.0 | 100.1 | 100.1 | 100.0 |
| | amount | | | | | | | | | |
| F2 light | L* | 25.09 | 24.74 | 25.70 | 25.97 | 25.64 | 27.59 | 25.68 | 25.70 | 25.75 |
| source | a* | −0.47 | −0.05 | −0.84 | −0.83 | −0.64 | −0.69 | 0.66 | 0.50 | 0.61 |
| | b* | −0.41 | −1.08 | −1.33 | −2.33 | −1.75 | −4.82 | −5.80 | −5.86 | −5.69 |
| D65 light | L* | 25.10 | 24.80 | — | — | — | — | — | — | — |
| source | a* | −0.39 | −0.11 | −0.54 | −0.42 | −0.29 | −0.13 | 1.33 | 1.16 | 1.73 |
| | b* | −0.35 | −0.92 | — | — | −1.61 | −4.36 | −5.23 | −5.29 | −5.55 |
| D65-F2 | Δa* | 0.08 | −0.06 | 0.30 | 0.41 | 0.35 | 0.56 | 0.67 | 0.66 | 1.12 |
| | Δb* | 0.06 | 0.16 | — | — | 0.14 | 0.46 | 0.57 | 0.57 | −0.14 |

| | | | | | | | | | |
|---|---|---|---|---|---|---|---|---|---|
| CS(MPa) | — | — | — | — | 909 | 954 | 864 | 864 | — |
| DOL(μm) | — | — | — | — | 50.5 | 37.6 | 7.1 | 7.1 | — |

TABLE 4

| | | mol % | | | | | | | | |
|---|---|---|---|---|---|---|---|---|---|---|
| | | Example | Example | Example | Example | Example | Example | Example | Example | Example |
| | | 29 | 30 | 31 | 32 | 33 | 34 | 35 | 36 | 37 |
| | SiO₂ | 63.3 | 63.3 | 63.3 | 67.0 | 63.2 | 64.8 | 62.9 | 58.9 | 62.9 |
| | Al₂O₃ | 7.8 | 7.8 | 7.8 | 10.7 | 7.9 | 8.8 | 10.8 | 13.8 | 11.8 |
| | Na₂O | 6.4 | 8.3 | 10.3 | 15.3 | 14.3 | 14.7 | 14.7 | 17.7 | 15.7 |
| | K₂O | 9.8 | 7.8 | 5.9 | 0 | 3.9 | 2.0 | 1.0 | 0 | 0 |
| | CaO | 0 | 0 | 0 | 0.1 | 0 | 0 | 0 | 0 | 0 |
| | MgO | 10.3 | 10.3 | 10.3 | 5.1 | 8.4 | 7.9 | 8.8 | 7.9 | 7.9 |
| | ZrO₂ | 0.4 | 0.4 | 0.4 | 0 | 0.4 | 0 | 0 | 0 | 0 |
| | Fe₂O₃ | 0 | 0 | 0 | 0 | 1.0 | 0 | 0 | 0 | 0 |
| | CuO | 0.98 | 0.98 | 0.98 | 0.98 | 0 | 0.98 | 0.98 | 0.98 | 0.98 |
| | V₂O₅ | 0 | 0 | 0 | 0 | 0 | 0 | 0 | 0 | 0 |
| | NiO | 0.64 | 0.64 | 0.64 | 0.64 | 0.54 | 0.65 | 0.65 | 0.65 | 0.65 |
| | Co₃O₄ | 0.05 | 0.05 | 0.05 | 0.05 | 0.06 | 0.05 | 0.05 | 0.05 | 0.05 |
| | TiO₂ | 0.24 | 0.24 | 0.24 | 0 | 0.25 | 0 | 0 | 0 | 0 |
| | Cl | 0 | 0 | 0 | 0 | 0 | 0 | 0 | 0 | 0 |
| | SO₃ | 0.1 | 0.1 | 0.1 | 0.1 | 0.1 | 0.1 | 0.1 | 0.1 | 0.1 |
| | Total | 100.0 | 99.9 | 100.0 | 100.0 | 100.1 | 100.0 | 100.0 | 100.1 | 100.1 |
| | amount | | | | | | | | | |
| F2 light | L* | 26.04 | 26.29 | 26.45 | 26.98 | 26.33 | 25.72 | 27.35 | 28.06 | 27.58 |
| source | a* | 0.38 | −0.14 | −0.49 | −0.82 | −0.37 | 0.42 | −1.85 | −2.05 | −2.07 |
| | b* | −4.35 | −3.27 | −2.62 | −2.19 | −2.33 | −5.23 | 0.13 | 0.46 | 1.01 |
| D65 light | L* | — | — | — | — | — | — | — | — | — |
| source | a* | 1.47 | 0.77 | 0.32 | 0.13 | 0.36 | 1.52 | −1.39 | −1.65 | −1.66 |
| | b* | −4.32 | −3.31 | −2.71 | −2.28 | −2.17 | −5.09 | −0.10 | 0.19 | 0.71 |
| D65-F2 | Δa* | 1.09 | 0.91 | 0.81 | 0.95 | 0.73 | 1.10 | 0.46 | 0.40 | 0.41 |
| | Δb* | −0.03 | 0.04 | −0.09 | −0.09 | 0.16 | 0.14 | −0.23 | −0.27 | −0.30 |

| | | | | | | | | | |
|---|---|---|---|---|---|---|---|---|---|
| CS(MPa) | 396 | 535 | 692 | 1113 | 935 | 940 | 1107 | 1293 | 1202 |
| DOL(μm) | 44 | 54 | 46 | 35 | 43 | 37 | 31 | 31 | 29 |

TABLE 5

| | | mol % | | | | | | | | |
|---|---|---|---|---|---|---|---|---|---|---|
| | | Example | Example | Example | Example | Example | Example | Example | Example | Example |
| | | 38 | 39 | 40 | 41 | 42 | 43 | 44 | 45 | 46 |
| | SiO₂ | 66.8 | 66.9 | 64.3 | 71.0 | 71.7 | 71.4 | 63.8 | 65.3 | 63.7 |
| | Al₂O₃ | 9.8 | 10.7 | 8.0 | 1.4 | 1.1 | 1.4 | 7.9 | 7.9 | 7.9 |
| | Na₂O | 13.8 | 14.8 | 12.5 | 14.4 | 12.5 | 12.5 | 12.4 | 13.9 | 12.4 |
| | K₂O | 0 | 0 | 4.0 | 0.2 | 0.2 | 0.2 | 4.0 | 4.0 | 4.0 |
| | CaO | 0 | 0.1 | 0 | 6.2 | 8.6 | 8.2 | 0 | 0 | 0 |
| | MgO | 7.9 | 5.7 | 10.5 | 5.9 | 5.5 | 5.5 | 10.4 | 7.4 | 10.4 |
| | ZrO₂ | 0 | 0 | 0.5 | 0 | 0 | 0 | 0.4 | 0.4 | 0.5 |
| | Fe₂O₃ | 0 | 0 | 0 | 0.84 | 0.12 | 0 | 0 | 0 | 0.01 |
| | CuO | 0.98 | 0.98 | 0 | 0 | 0 | 0.25 | 0 | 0 | 0 |
| | V₂O₅ | 0 | 0 | 0.5 | 0 | 0 | 0 | 0 | 0 | 0 |
| | NiO | 0.65 | 0.64 | 0 | 0 | 0 | 0.4 | 0.99 | 0.65 | 0.50 |
| | Co₃O₄ | 0.05 | 0.05 | 0.01 | 0 | 0.02 | 0.03 | 0 | 0.05 | 0.06 |
| | TiO₂ | 0 | 0 | 0 | 0 | 0 | 0 | 0 | 0.25 | 0.50 |
| | Cl | 0 | 0 | 0 | 0 | 0 | 0 | 0 | 0 | 0 |
| | SO₃ | 0.1 | 0.1 | 0 | 0.1 | 0.1 | 0.1 | 0.1 | 0.1 | 0.1 |
| | Total | 100.1 | 100.0 | 100.3 | 100.3 | 99.8 | 100.0 | 100.0 | 100.0 | 100.1 |
| | amount | | | | | | | | | |
| F2 light | L* | 27.79 | 26.74 | 77.24 | 86.58 | 49.80 | 37.49 | 31.12 | 25.08 | 28.18 |
| source | a* | −2.28 | −1.05 | −4.56 | −3.78 | −3.20 | −3.10 | 5.66 | 2.85 | 0.55 |
| | b* | 1.08 | −1.68 | −11.42 | 8.11 | −10.26 | −5.39 | 9.77 | −10.46 | −9.71 |
| D65 light | L* | — | — | 77.79 | 86.50 | 50.27 | 37.72 | 30.39 | 25.26 | 28.30 |
| source | a* | −1.76 | −0.25 | −4.65 | −5.69 | −1.80 | −2.00 | 9.18 | 5.59 | 3.11 |
| | b* | 0.74 | −1.81 | −9.76 | 7.35 | −9.04 | −5.03 | 8.37 | −10.03 | −9.14 |
| D65-F2 | Δa* | 0.52 | 0.80 | −0.09 | −1.91 | 1.40 | 1.10 | 3.52 | 2.74 | 2.56 |
| | Δb* | −0.34 | −0.13 | 1.66 | −0.76 | 1.22 | 0.36 | −1.40 | 0.43 | 0.57 |

| | | | | | | | | | |
|---|---|---|---|---|---|---|---|---|---|
| CS(MPa) | 1085 | 1115 | — | — | — | — | — | — | — |
| DOL(μm) | 29 | 35 | — | — | — | — | — | — | — |

TABLE 6

| | | mol % | | | | | | | | |
|---|---|---|---|---|---|---|---|---|---|---|
| | | Example | Example | Example | Example | Example | Example | Example | Example | Example |
| | | 47 | 48 | 49 | 50 | 51 | 52 | 53 | 54 | 55 |
| | SiO₂ | 70.4 | 71.2 | 70.9 | 70.9 | 71.2 | 64.1 | 71.3 | 71.3 | 71.3 |
| | B₂O₃ | 0 | 0 | 0 | 0 | 0 | 5.1 | 0 | 0 | 0 |
| | Al₂O₃ | 3.1 | 3.1 | 5.1 | 8.1 | 3.1 | 14.3 | 4.1 | 4.1 | 4.1 |
| | Na₂O | 16.5 | 16.6 | 14.6 | 14.6 | 16.6 | 13.9 | 15.7 | 15.7 | 15.7 |
| | K₂O | 0.2 | 0.2 | 0.2 | 0.2 | 0.2 | 0 | 0.2 | 0.2 | 0.2 |
| | CaO | 0 | 0 | 0 | 0 | 0 | 0 | 0 | 0 | 0 |
| | MgO | 8.4 | 8.5 | 8.5 | 5.5 | 8.5 | 2.3 | 8.5 | 8.5 | 8.5 |
| | ZrO₂ | 0 | 0 | 0 | 0 | 0 | 0 | 0 | 0 | 0 |
| | Fe₂O₃ | 0 | 0 | 0 | 0 | 0 | 0 | 0 | 0.01 | 0.005 |
| | CuO | 0.7 | 0.13 | 0.4 | 0.3 | 0.13 | 0.13 | 0.04 | 0.04 | 0.02 |
| | Se | 0 | 0 | 0 | 0 | 0 | 0 | 0 | 0 | 0 |
| | V₂O₅ | 0 | 0 | 0 | 0 | 0 | 0 | 0 | 0 | 0 |
| | NiO | 0.6 | 0.14 | 0.28 | 0.13 | 0.14 | 0.14 | 0.07 | 0.07 | 0.04 |
| | Co₃O₄ | 0.007 | 0.0018 | 0.003 | 0.006 | 0.0008 | 0.007 | 0.002 | 0.002 | 0.002 |
| | TiO₂ | 0 | 0 | 0 | 0 | 0 | 0 | 0 | 0 | 0 |
| | MnO₂ | 0 | 0 | 0 | 0 | 0 | 0 | 0 | 0 | 0 |
| | Er₂O₃ | 0 | 0 | 0 | 0 | 0 | 0 | 0 | 0 | 0 |
| | Cl | 0 | 0 | 0 | 0 | 0 | 0 | 0 | 0 | 0 |
| | SO₃ | 0.1 | 0.1 | 0.1 | 0.1 | 0.1 | 0.1 | 0.1 | 0.1 | 0.1 |
| | Total | 100.01 | 99.97 | 100.08 | 99.84 | 99.97 | 100.08 | 100.01 | 100.02 | 99.97 |
| | amount | | | | | | | | | |
| F2 light | L* | 32.90 | 60.79 | 42.33 | 56.70 | 62.23 | 66.42 | 73.34 | 73.29 | 76.21 |
| source | a* | −0.23 | 0.35 | −0.34 | −0.22 | 0.63 | −1.38 | 0.10 | 0.72 | −0.13 |
| | b* | −1.43 | 0.54 | 1.73 | −3.36 | 2.70 | 10.25 | −4.00 | −2.78 | −3.06 |
| D65 light | L* | 32.65 | 60.39 | 41.77 | 56.4 | 61.72 | 65.75 | 73.29 | 73.34 | 76.15 |
| source | a* | 0.82 | 1.13 | 0.63 | 1.43 | 1.38 | −0.43 | 0.72 | 0.10 | 0.22 |
| | b* | −1.82 | 1.06 | 1.40 | −2.41 | 2.97 | 9.37 | −2.78 | −4.00 | −1.94 |
| D65-F2 | Δa* | 1.05 | 0.78 | 0.97 | 1.65 | 0.75 | 0.95 | 0.62 | −0.62 | 0.35 |
| | Δb* | −0.39 | 0.52 | −0.33 | 0.95 | 0.27 | −0.88 | 1.22 | −1.22 | 1.12 |

| | | | | | | | | | |
|---|---|---|---|---|---|---|---|---|---|
| CS(MPa) | — | — | — | — | — | — | — | — | — |
| DOL(μm) | — | — | — | — | — | — | — | — | — |

TABLE 7

| | | mol % | | | | | | | | |
|---|---|---|---|---|---|---|---|---|---|---|
| | | Example | Example | Example | Example | Example | Example | Example | Example | Example |
| | | 56 | 57 | 58 | 59 | 60 | 61 | 63 | 64 | 65 |
| | SiO₂ | 71.2 | 70.1 | 63.3 | 70.2 | 70.9 | 70.2 | 71.2 | 71.4 | 69.4 |
| | B₂O₃ | 0 | 0 | 5.0 | 0 | 0 | 0 | 0 | 0 | 0 |
| | Al₂O₃ | 3.1 | 8.1 | 13.7 | 6 | 5.1 | 6 | 3.1 | 3.1 | 3.1 |
| | Na₂O | 16.6 | 14.6 | 14.7 | 13.6 | 14.6 | 13.6 | 16.6 | 14.5 | 16.5 |
| | K₂O | 0.2 | 0.2 | 0 | 0.2 | 0.2 | 0.2 | 0.2 | 0.2 | 0.2 |
| | CaO | 0 | 0 | 0 | 0 | 0 | 0 | 0 | 0 | 0 |
| | MgO | 8.5 | 5.5 | 1.5 | 8.2 | 8.5 | 8.2 | 8.5 | 9.4 | 9.4 |
| | ZrO₂ | 0 | 0 | 0 | 0 | 0 | 0 | 0 | 0 | 0 |
| | Fe₂O₃ | 0.005 | 0.15 | 0.015 | 0.99 | 0.02 | 0.99 | 0.01 | 0.005 | 0.02 |
| | CuO | 0.13 | 0.3 | 0.98 | 0 | 0.37 | 0 | 0.13 | 0.74 | 0.74 |
| | Se | 0 | 0 | 0 | 0 | 0 | 0 | 0 | 0 | 0 |
| | V₂O₅ | 0 | 0 | 0 | 0 | 0 | 0 | 0 | 0 | 0 |
| | NiO | 0.14 | 0.13 | 0.69 | 0.575 | 0.275 | 0.58 | 0.14 | 0.55 | 0.55 |
| | Co₃O₄ | 0.0008 | 0.006 | 0.056 | 0.065 | 0.003 | 0.064 | 0.0018 | 0.01 | 0.007 |
| | TiO₂ | 0 | 0 | 0 | 0 | 0 | 0 | 0 | 0 | 0 |
| | MnO₂ | 0 | 0 | 0 | 0 | 0 | 0 | 0 | 0 | 0 |
| | Er₂O₃ | 0 | 0 | 0 | 0 | 0 | 0 | 0 | 0 | 0 |
| | Cl | 0 | 0 | 0 | 0 | 0 | 0 | 0 | 0 | 0 |
| | SO₃ | 0.1 | 0.1 | 0.1 | 0.1 | 0.1 | 0.1 | 0.1 | 0.1 | 0.1 |
| | Total | 99.98 | 99.19 | 100.04 | 99.93 | 100.07 | 99.94 | 99.98 | 100.01 | 100.02 |
| | amount | | | | | | | | | |
| F2 light | L* | 61.72 | 56.87 | 26.66 | 25.83 | 42.33 | 25.82 | 60.79 | 32.58 | 33.51 |
| source | a* | 1.38 | −0.17 | −0.87 | −0.51 | −0.34 | −0.51 | 0.35 | −0.67 | −0.68 |
| | b* | 2.97 | −3.14 | −1.14 | −1.90 | 1.73 | −1.84 | 0.54 | −0.51 | 0.20 |
| D65 light | L* | 62.23 | 56.57 | 26.60 | 25.83 | 41.77 | 25.82 | 60.39 | 32.30 | 33.21 |
| source | a* | 0.63 | 1.49 | −0.15 | 0.29 | 0.63 | 0.33 | 1.13 | 0.34 | 0.14 |
| | b* | 2.70 | −2.21 | −1.19 | −1.86 | 1.40 | −1.82 | 1.06 | −0.98 | −0.34 |
| D65-F2 | Δa* | −0.75 | 1.66 | 0.72 | 0.80 | 0.97 | 0.84 | 0.78 | 1.01 | 0.82 |
| | Δb* | −0.27 | 0.93 | −0.05 | 0.04 | −0.33 | 0.02 | 0.52 | −0.47 | −0.54 |

| | | | | | | | | | |
|---|---|---|---|---|---|---|---|---|---|
| CS(MPa) | — | — | — | — | — | — | — | — | — |
| DOL(μm) | — | — | — | — | — | — | — | — | — |

TABLE 8

| | | mol % | | | | | | | | |
|---|---|---|---|---|---|---|---|---|---|---|
| | | Example | Example | Example | Example | Example | Example | Example | Example | Example |
| | | 66 | 67 | 68 | 69 | 70 | 71 | 72 | 73 | 74 |
| | SiO₂ | 66.8 | 65.2 | 66.6 | 69.3 | 64.2 | 63.3 | 68.3 | 72.3 | 70.3 |
| | B₂O₃ | 3.6 | 5.2 | 2.6 | 1.0 | 5.1 | 5.0 | 1.0 | 0 | 0 |
| | Al₂O₃ | 7.7 | 9.6 | 11.4 | 7.7 | 11.0 | 14.1 | 5.8 | 9.7 | 10.7 |
| | Na₂O | 13.7 | 13.8 | 14.2 | 12.5 | 13.6 | 13.4 | 11.5 | 11.5 | 13.5 |
| | K₂O | 0.1 | 0 | 0 | 0 | 0 | 0 | 0 | 0 | 0 |
| | CaO | 0 | 0 | 0 | 0 | 0 | 0 | 0 | 0 | 0 |
| | MgO | 4.3 | 2.3 | 2.4 | 5.8 | 2.3 | 2.3 | 9.6 | 2.9 | 1.9 |
| | ZrO₂ | 0 | 0 | 0 | 0 | 0 | 0 | 0 | 0 | 0 |
| | Fe₂O₃ | 3.39 | 3.43 | 2.43 | 3.27 | 3.38 | 1.37 | 3.27 | 3.27 | 3.27 |
| | CuO | 0 | 0 | 0 | 0 | 0 | 0 | 0 | 0 | 0 |
| | Se | 0 | 0 | 0 | 0 | 0 | 0 | 0 | 0 | 0 |
| | V₂O₅ | 0 | 0 | 0 | 0 | 0 | 0 | 0 | 0 | 0 |
| | NiO | 0 | 0 | 0 | 0 | 0 | 0 | 0 | 0 | 0 |
| | Co₃O₄ | 0.40 | 0.40 | 0.41 | 0.38 | 0.40 | 0.39 | 0.38 | 0.38 | 0.38 |
| | TiO₂ | 0 | 0 | 0 | 0 | 0 | 0 | 0 | 0 | 0 |
| | MnO₂ | 0 | 0 | 0 | 0 | 0 | 0 | 0 | 0 | 0 |
| | Er₂O₃ | 0 | 0 | 0 | 0 | 0 | 0 | 0 | 0 | 0 |
| | Cl | 0 | 0 | 0 | 0 | 0 | 0 | 0 | 0 | 0 |
| | SO₃ | 0.1 | 0.1 | 0.1 | 0.1 | 0.1 | 0.1 | 0.1 | 0.1 | 0.1 |
| | Total | 99.90 | 99.90 | 99.90 | 99.90 | 99.90 | 99.90 | 99.90 | 99.90 | 99.90 |
| | amount | | | | | | | | | |
| F2 light | L* | 24.96 | 25.05 | 24.64 | 24.98 | 25.47 | 24.46 | 27.25 | 24.88 | 24.84 |
| source | a* | 0.00 | 0.02 | 0.03 | −0.01 | 0.00 | 0.04 | 0.39 | 0.07 | 0.11 |
| | b* | −0.81 | −0.92 | −0.74 | −0.78 | −0.82 | −0.51 | −0.01 | −0.61 | −0.59 |
| D65 light | L* | 25.00 | 25.10 | 24.68 | 25.01 | 25.51 | 24.48 | 27.24 | 24.91 | 24.86 |
| source | a* | 0.01 | 0.01 | 0.03 | −0.03 | 0.01 | 0.05 | 0.56 | 0.07 | 0.13 |
| | b* | −0.69 | −0.78 | −0.63 | −0.67 | −0.71 | −0.42 | 0.00 | −0.51 | −0.51 |
| D65-F2 | Δa* | 0.01 | −0.01 | 0.00 | −0.02 | 0.01 | 0.01 | 0.17 | 0.00 | 0.02 |
| | Δb* | 0.12 | 0.14 | 0.11 | 0.11 | 0.11 | 0.09 | 0.01 | 0.10 | 0.08 |

| | | | | | | | | | |
|---|---|---|---|---|---|---|---|---|---|
| CS(MPa) | — | — | — | 982 | — | 1075 | — | — | — |
| DOL(μm) | — | — | — | 21.1 | — | 32 | — | — | — |

TABLE 9

| | | mol % | | | | | | | | |
|---|---|---|---|---|---|---|---|---|---|---|
| | | Example | Example | Example | Example | Example | Example | Example | Example | Example |
| | | 75 | 76 | 77 | 78 | 79 | 80 | 81 | 82 | 83 |
| | SiO₂ | 69.5 | 70.3 | 70.3 | 69.3 | 62.79 | 62.73 | 70.32 | 70.19 | 71.65 |
| | B₂O₃ | 0 | 0 | 0 | 0 | 0 | 0 | 0 | 0 | 0 |
| | Al₂O₃ | 5.8 | 7.7 | 8.7 | 5.8 | 7.81 | 7.8 | 1.07 | 1.07 | 1.11 |
| | Na₂O | 11.6 | 12.5 | 13.5 | 11.5 | 12.21 | 12.29 | 12.31 | 12.28 | 12.59 |
| | K₂O | 0 | 0 | 0 | 0 | 3.91 | 3.9 | 0.2 | 0.19 | 0.19 |
| | CaO | 0 | 0 | 0 | 0 | 0 | 0 | 8.4 | 8.38 | 8.6 |
| | MgO | 9.7 | 5.8 | 3.8 | 9.6 | 10.25 | 10.15 | 5.37 | 5.36 | 5.47 |
| | ZrO₂ | 0 | 0 | 0 | 0 | 0.49 | 0.49 | 0 | 0 | 0 |
| | Fe₂O₃ | 2.95 | 3.27 | 3.27 | 3.27 | 1.87 | 1.86 | 1.77 | 1.95 | 0 |
| | CuO | 0 | 0 | 0 | 0 | 0 | 0 | 0 | 0 | 0 |
| | Se | 0 | 0 | 0 | 0 | 0.49 | 0.49 | 0.27 | 0.27 | 0.29 |
| | V₂O₅ | 0 | 0 | 0 | 0 | 0 | 0 | 0 | 0 | 0 |
| | NiO | 0 | 0 | 0 | 0 | 0 | 0 | 0 | 0 | 0 |
| | Co₃O₄ | 0.39 | 0.38 | 0.38 | 0.38 | 0.1 | 0.1 | 0.1 | 0.1 | 0.01 |
| | TiO₂ | 0 | 0 | 0 | 0 | 0 | 0 | 0 | 0 | 0 |
| | MnO₂ | 0 | 0 | 0 | 0 | 0 | 0 | 0 | 0 | 0 |
| | Er₂O₃ | 0 | 0 | 0 | 0 | 0 | 0 | 0 | 0 | 0 |
| | Cl | 0 | 0 | 0 | 0 | 0 | 0.2 | 0.2 | 0.19 | 0 |
| | SO₃ | 0.1 | 0.1 | 0.1 | 0.1 | 0.1 | 0 | 0 | 0 | 0.1 |
| | Total | 99.90 | 99.90 | 99.90 | 99.90 | 100.02 | 100.01 | 100.01 | 99.98 | 100.01 |
| | amount | | | | | | | | | |
| F2 light | L* | 25.01 | 24.99 | 24.88 | 25.10 | 25.86 | 25.76 | 25.44 | 25.38 | 71.67 |
| source | a* | 0.02 | 0.03 | 0.05 | 0.07 | −0.71 | −0.69 | 0.19 | 0.02 | −1.58 |
| | b* | −0.66 | −0.59 | −0.69 | −0.66 | −2.77 | −1.38 | −3.16 | −2.46 | −32.9 |
| D65 light | L* | 25.05 | 25.01 | 24.9 | 25.13 | — | — | — | — | — |
| source | a* | 0.01 | 0.04 | 0.06 | 0.08 | −0.26 | −0.36 | 0.58 | 0.29 | −0.12 |
| | b* | −0.56 | −0.50 | −0.59 | −0.58 | — | — | −2.84 | −2.19 | −29.63 |
| D65-F2 | Δa* | −0.01 | 0.01 | 0.01 | 0.01 | 0.45 | 0.33 | 0.39 | 0.27 | 1.46 |
| | Δb* | 0.10 | 0.09 | 0.10 | 0.08 | — | — | 0.32 | 0.27 | 3.27 |

| | | | | | | | | | |
|---|---|---|---|---|---|---|---|---|---|
| CS(MPa) | 901 | 1003 | 1084 | 900 | — | — | — | — | — |
| DOL(μm) | 15 | 22 | 26 | 16.4 | — | — | — | — | — |

TABLE 10

| | | mol % | | | | | | | | |
|---|---|---|---|---|---|---|---|---|---|---|
| | | Example | Example | Example | Example | Example | Example | Example | Example | Example |
| | | 84 | 85 | 86 | 87 | 88 | 89 | 90 | 91 | 92 |
| | SiO₂ | 71.3 | 71.3 | 71.58 | 71.5 | 71.5 | 71.1 | 69.4 | 70.8 | 70.9 |
| | B₂O₃ | 0 | 0 | 0 | 0 | 0 | 0 | 0 | 0 | 0 |
| | Al₂O₃ | 4.1 | 4.1 | 1.1 | 1.1 | 1.1 | 4.1 | 4.1 | 5.1 | 5.1 |
| | Na₂O | 15.7 | 15.7 | 12.5 | 12.5 | 12.5 | 15.4 | 13.5 | 14.6 | 14.6 |
| | K₂O | 0.2 | 0.2 | 0.2 | 0.2 | 0.2 | 0.2 | 0.2 | 0.2 | 0.2 |
| | CaO | 0 | 0 | 8.5 | 8.5 | 8.5 | 2.6 | 0 | 0 | 0 |
| | MgO | 8.5 | 8.5 | 5.5 | 5.5 | 5.5 | 5.4 | 11.4 | 8.5 | 8.5 |
| | ZrO₂ | 0 | 0 | 0 | 0 | 0 | 0 | 0 | 0 | 0 |
| | Fe₂O₃ | 0 | 0 | 0.25 | 0 | 0 | 0 | 0 | 0.20 | 0.15 |
| | CuO | 0 | 0 | 0 | 0.20 | 0.20 | 0.74 | 0.74 | 0.37 | 0.35 |
| | Se | 0 | 0 | 0 | 0 | 0 | 0 | 0 | 0 | 0 |
| | V₂O₅ | 0.04 | 0.08 | 0 | 0 | 0 | 0 | 0 | 0 | 0 |
| | NiO | 0.07 | 0.07 | 0.22 | 0.22 | 0.22 | 0.35 | 0.55 | 0.17 | 0.07 |
| | Co₃O₄ | 0.002 | 0.002 | 0.02 | 0.021 | 0.021 | 0.021 | 0.012 | 0.003 | 0.003 |
| | TiO₂ | 0 | 0 | 0 | 0 | 0 | 0 | 0 | 0 | 0 |
| | MnO₂ | 0 | 0 | 0 | 0 | 0.2 | 0 | 0 | 0 | 0 |
| | Er₂O₃ | 0 | 0 | 0 | 0.1 | 0 | 0 | 0 | 0 | 0 |
| | Cl | 0 | 0 | 0 | 0 | 0 | 0 | 0 | 0 | 0 |
| | SO₃ | 0.1 | 0.1 | 0.1 | 0.1 | 0.1 | 0.1 | 0.1 | 0.1 | 0.1 |
| | Total | 100.01 | 100.05 | 100.00 | 100.00 | 100.00 | 100.00 | 100.00 | 100.00 | 100.00 |
| | amount | | | | | | | | | |
| F2 light | L* | 74.09 | 73.68 | 48.38 | 47.48 | 47.73 | 38.30 | 35.77 | 53.83 | 66.99 |
| source | a* | 0.56 | 0.53 | −3.60 | −4.16 | −3.85 | −2.80 | −2.51 | −0.42 | −3.90 |
| | b* | −1.26 | −3.86 | −9.64 | −12.93 | −12.47 | −15.34 | 7.32 | 8.54 | −1.56 |
| D65 light | L* | 73.91 | 73.60 | 48.85 | 48.10 | 48.21 | 38.98 | 35.21 | 53.09 | 67.02 |
| source | a* | 1.37 | 1.41 | −2.41 | −3.39 | −2.73 | −2.39 | −2.20 | 0.54 | −4.69 |
| | b* | −0.36 | −2.68 | −8.52 | −11.36 | −11.17 | −13.36 | 6.06 | 7.91 | −0.70 |
| D65-F2 | Δa* | 0.81 | 0.88 | 1.19 | 0.77 | 1.12 | 0.41 | 0.31 | 0.96 | −0.79 |
| | Δb* | 0.90 | 1.18 | 1.12 | 1.57 | 1.30 | 1.98 | −1.26 | −0.63 | 0.86 |

| | | | | | | | | | |
|---|---|---|---|---|---|---|---|---|---|
| CS(MPa) | — | — | — | — | — | — | — | — | — |
| DOL(μm) | — | — | — | — | — | — | — | — | — |

TABLE 11

| | | mol % | | | | | | |
|---|---|---|---|---|---|---|---|---|
| | | Example | Example | Example | Example | Example | Example | Example |
| | | 93 | 94 | 95 | 96 | 97 | 98 | 99 |
| | SiO₂ | 64.0 | 72.3 | 71.3 | 71.0 | 68.8 | 68.3 | 71.7 |
| | B₂O₃ | 5.1 | 0 | 0 | 0 | 0 | 0 | 0 |
| | Al₂O₃ | 14.3 | 3.1 | 4.1 | 5.8 | 5.7 | 5.7 | 1.1 |
| | Na₂O | 13.9 | 15.7 | 15.7 | 11.5 | 11.46 | 11.38 | 12.6 |
| | K₂O | 0 | 0.2 | 0.2 | 0 | 0 | 0 | 0.2 |
| | CaO | 0 | 0 | 0 | 0 | 0 | 0 | 8.57 |
| | MgO | 2.3 | 8.5 | 8.5 | 7.67 | 9.55 | 9.46 | 5.5 |
| | ZrO₂ | 0 | 0 | 0 | 0 | 0 | 0 | 0 |
| | Fe₂O₃ | 0 | 0 | 0 | 3.64 | 4.01 | 4.68 | 0 |
| | CuO | 0.13 | 0.02 | 0.04 | 0 | 0 | 0 | 0 |
| | Se | 0 | 0 | 0 | 0 | 0 | 0 | 0 |
| | V₂O₅ | 0 | 0 | 0 | 0 | 0 | 0 | 0 |
| | NiO | 0.14 | 0.04 | 0.07 | 0 | 0 | 0 | 0.22 |
| | Co₃O₄ | 0.002 | 0.003 | 0.003 | 0.39 | 0.39 | 0.41 | 0.031 |
| | TiO₂ | 0 | 0 | 0 | 0 | 0 | 0 | 0 |
| | MnO₂ | 0 | 0 | 0 | 0 | 0 | 0 | 0 |
| | Er₂O₃ | 0 | 0 | 0 | 0 | 0 | 0 | 0 |
| | Cl | 0 | 0 | 0 | 0 | 0 | 0 | 0 |
| | SO₃ | 0.1 | 0.1 | 0.1 | 0.1 | 0.1 | 0.1 | 0.1 |
| | Total | 100.00 | 100.00 | 100.00 | 100.00 | 100.00 | 100.01 | 100.02 |
| | amount | | | | | | | |
| F2 light | L* | 71.87 | 73.06 | 82.48 | 25.02 | 25.20 | 25.49 | 42.19 |
| source | a* | 1.03 | −1.12 | −0.26 | −0.04 | −0.01 | −0.08 | −1.63 |
| | b* | 18.56 | −13.10 | −3.49 | −0.91 | −1.01 | −0.97 | −20.10 |
| D65 light | L* | 70.84 | 73.60 | 82.54 | 25.05 | 25.22 | 25.53 | 43.06 |
| source | a* | 2.18 | −0.64 | −0.16 | −0.04 | −0.01 | −0.12 | 0.82 |
| | b* | 16.72 | −10.87 | −2.36 | −0.79 | −0.86 | −0.80 | −17.86 |
| D65-F2 | Δa* | 1.15 | 0.48 | 0.10 | 0.00 | 0.00 | −0.04 | 2.45 |
| | Δb* | −1.84 | 2.23 | 1.13 | 0.12 | 0.15 | 0.17 | 2.24 |

| | | | | | | | |
|---|---|---|---|---|---|---|---|
| CS(MPa) | — | — | — | — | — | — | — |
| DOL(μm) | — | — | — | — | — | — | — |

As illustrated in Table 1 to Table 11, in each of the glasses of the examples of the present invention containing at least one component selected from a group consisting of Fe₂O₃, CuO, V₂O₅, and Se, Δa* which is the index of the metamerism is 2.0 or less, from which it can be seen that the metamerism can be suppressed. Further, in each of the glasses of the examples of the present invention except Example 10, Example 22, Example 23, Example 83, Example 94, both of Δa* and Δb* are 2.0 or less, from which it can be seen that the metamerism can be further suppressed. In contrast, in the glasses of the comparative examples (Example 44 to Example 46, Example 99) containing a total amount of at least one component selected from a group consisting of Fe₂O₃, CuO, V₂O₅, and Se of no more than 0.01%, Δa* exceeds 2.0, so that the metamerism cannot be suppressed.

Further, it can be seen that each of the glasses in the examples of the present invention evaluated regarding CS and DOL is a glass having a high mechanical strength owing to chemical strengthening performed thereon.

Subsequently, regarding the glasses (Example 7, Example, 8, Example 21, Example 24 to Example 27, Example 29 to Example 39, Example 48 to Example 50, Example 57 to Example 65, Example 81 to Example 82), the color tone after the chemical strengthening was measured. As the color tone of each glass, the chromaticity of reflected light in the L*a*b* color system standardized by CIE was measured similarly to the above. Using an F2 light source and a D65 light source as the light source, the chromaticity of the reflected light was measured for each of them. The chromaticity measurement of the reflected light in the L*a*b* color system was performed using the spectro-colorimeter (Colori7 made by X-Rite, Inc.). Note that on a rear face side (the rear face of a face irradiated with light from the light source) of the glass, a white resin plate was placed to perform measurement.

The chemical strengthening was carried out by immersing the glass for 6 hours in a molten salt made of KNO₃ (99%) and NaNO₃ (1%) at 450° C. Further, after the chemical strengthening, the glass was cooled by a process of lowering the temperature of the glass from 450° C. to 300° C. under a cooling condition of 400° C. or more/min.
The above evaluation results are illustrated in Table 12 to Table 15.

TABLE 12

| | | Example | Example | Example | Example | Example | Example | Example | Example | Example |
|---|---|---|---|---|---|---|---|---|---|---|
| | | 7 | 8 | 21 | 24 | 25 | 26 | 27 | 29 | 30 |
| F2 light | L* | 26.85 | 25.88 | 17.34 | 25.95 | 26.51 | 25.95 | 26.00 | 25.93 | 26.25 |
| source | a* | −0.55 | −0.38 | 0.56 | −0.69 | −0.88 | 0.75 | 0.53 | 0.49 | 0.01 |
| | b* | −3.40 | −2.55 | −3.95 | −2.03 | −3.92 | −5.94 | −5.36 | −4.58 | −3.63 |
| D65 light | a* | 0.21 | 0.00 | 0.77 | −0.30 | −0.34 | 1.46 | 1.13 | 1.56 | 0.91 |
| source | b* | −3.36 | −2.28 | −3.42 | −1.88 | −3.59 | −5.37 | −4.86 | −4.48 | −3.61 |
| D65-F2 | Δa* | 0.76 | 0.38 | 0.21 | 0.39 | 0.54 | 0.71 | 0.60 | 1.07 | 0.90 |
| | Δb* | 0.04 | 0.27 | 0.53 | 0.15 | 0.33 | 0.57 | 0.50 | 0.10 | 0.02 |

TABLE 13

| | | Example | Example | Example | Example | Example | Example | Example | Example | Example |
|---|---|---|---|---|---|---|---|---|---|---|
| | | 31 | 32 | 33 | 34 | 35 | 36 | 37 | 38 | 39 |
| F2 light | L* | 26.40 | 27.15 | 26.55 | 25.96 | 23.29 | 28.48 | 26.04 | 28.23 | 27.03 |
| source | a* | −0.30 | −0.55 | −0.49 | 0.43 | −1.79 | −1.84 | −1.95 | −2.19 | −0.97 |
| | b* | −3.02 | −2.94 | −2.15 | −5.73 | 1.93 | −0.07 | 2.43 | 0.69 | −2.06 |
| D65 light | a* | 0.50 | 0.49 | 0.24 | 1.57 | −0.96 | −1.31 | −1.39 | −1.67 | −0.15 |
| source | b* | −3.02 | −2.97 | −2.00 | −5.52 | 1.35 | −0.27 | 1.91 | 0.40 | −2.12 |
| D65-F2 | Δa* | 0.80 | 1.04 | 0.73 | 1.14 | 0.83 | 0.53 | 0.56 | 0.52 | 0.82 |
| | Δb* | 0.00 | −0.03 | 0.15 | 0.21 | −0.58 | −0.20 | −0.52 | −0.29 | −0.06 |

TABLE 14

| | | Example | Example | Example | Example |
|---|---|---|---|---|---|
| | | 48 | 58 | 59 | 64 |
| F2 light | L* | 59.49 | 28.44 | 26.15 | 32.32 |
| source | a* | 0.93 | −1.04 | −0.41 | −0.13 |
| | b* | −2.47 | −2.00 | −2.10 | −1.92 |
| D65 light | L* | 59.21 | 28.47 | 26.16 | 32.07 |
| source | a* | 1.89 | −0.64 | 0.40 | 1.01 |
| | b* | −1.65 | −1.87 | −2.02 | −2.23 |
| D65-F2 | Δa* | 0.96 | 0.40 | 0.81 | 1.14 |
| | Δb* | 0.82 | 0.13 | 0.08 | −0.31 |

TABLE 15

| | | Example | Example | Example |
|---|---|---|---|---|
| | | 65 | 81 | 82 |
| F2 light | L* | 33.13 | 25.71 | 25.64 |
| source | a* | −0.35 | 0.22 | 0.12 |
| | b* | −0.97 | −2.93 | −2.17 |
| D65 light | L* | 32.88 | — | — |
| source | a* | 0.53 | 0.63 | 0.44 |
| | b* | −1.38 | −2.64 | −1.96 |
| D65-F2 | Δa* | 0.88 | 0.41 | 0.32 |
| | Δb* | −0.41 | 0.29 | 0.21 |

As illustrated in Table 12 to Table 15, in each of the chemical strengthened glasses of the examples of the present invention containing at least one component selected from a group consisting of Fe₂O₃, CuO, and Se, both of Δa* and Δb* which are the indexes of the metamerism are 2.0 or less, from which it can be seen that the metamerism can be suppressed.

Next, analysis values of the glass compositions containing Se in the examples of the present invention listed in Table 1, Table 3, and Table 9 are shown in Table 16 and Table 17. The glass and the chemical strengthened glass listed here contain Se as the coloring component in the glass. When the glass raw material contains Se, Se volatilizes during a process of melting the glass raw material. Out of Se put in the glass raw material, a ratio of Se remaining in the glass (hereinafter, sometimes referred to as “Se residual ratio”) differs depending on a melting method of the glass raw material. For example, when the glass raw material is melted in a pot furnace, about 80% to about 99% of Se in the raw material sometimes volatilizes during the melting process.

In Example 79, Example 80, Example 25, Example 81, Example 82, Example 83 shown in Table 16 and Table 17, the glasses were produced by melting the glass raw materials composed of the components listed in Table 3 and Table 9, and the contents of the respective components obtained when the glasses were subjected to composition analysis by a wet analysis method are shown. In Example 10, Example 20 to Example 24 shown in Table 16, only the Se content is a calculation value calculated from an average value of the Se residual ratios of Example 79, Example 80, and Example 25, and the components other than Se are the same as those in Table 1, Table 3, and Table 9. Further, in Example 26 and Example 27 shown in Table 16 and Table 17, only the Se content is a calculation value calculated from an average value of the Se residual ratios of Example 81, Example 82, and Example 83, and the components other than Se are the same as those in Table 3 and Table 9.

The Se residual ratio, as is expressed by “Se residual ratio=(Se content in analysis value/Se content in preparatory composition)×100[%]”, indicates how much of an addition amount of Se at the time of the preparation remains when actual glass is formed, which is found by comparing the preparatory compositions shown in Table 1, Table 3, and Table 9 and the analysis values shown in Table 16 and Table 17 of the respective examples of the present invention. The average value of the Se residual ratios in Example 79, Example 80, and Example 25 is 0.65%. Further, the average value of the Se residual ratios of Example 81, Example 82, and Example 83 is 3.88%. As for each of the glasses of the examples of the present invention for which the analysis value of the Se content is not actually measured, a value equal to the Se content written in Table 1 to Table 11 multiplied by the Se residual ratio was written as the calculation value in Table 16 and Table 17. Note that a melting temperature of the glass raw material of the glass differs depending on the components that it contains. Since the Se residual ratio is influenced by the melting temperature of the glass raw material, the Se residual ratio was calculated for two separate groups as described above, considering the melting temperature of the glass raw material of each of the examples of the present invention.

TABLE 16

| | mol % | | | | | | | | |
|---|---|---|---|---|---|---|---|---|---|
| | Example | Example | Example | Example | Example | Example | Example | Example | Example |
| | 10 | 20 | 21 | 22 | 23 | 24 | 25 | 26 | 27 |
| SiO₂ | 64.04 | 67.11 | 62.85 | 62.7 | 62.91 | 62.85 | 62.99 | 70.39 | 70.26 |
| B₂O₃ | 0 | 0 | 6.78 | 0 | 0 | 0 | 0 | 0 | 0 |
| Al₂O₃ | 7.97 | 10.37 | 13.64 | 7.8 | 7.83 | 7.82 | 7.84 | 1.08 | 1.07 |
| Na₂O | 12.45 | 11.63 | 13.81 | 12.19 | 12.43 | 12.41 | 12.44 | 12.32 | 12.3 |
| K₂O | 3.98 | 2.23 | 0.5 | 3.9 | 3.91 | 3.91 | 3.92 | 0.2 | 0.2 |
| CaO | 0 | 0.34 | 0.07 | 0 | 0 | 0 | 0 | 8.41 | 8.39 |
| MgO | 10.46 | 5.38 | 0.02 | 10.24 | 10.08 | 10.07 | 10.09 | 5.38 | 5.37 |
| ZrO₂ | 0.5 | 0 | 0 | 0.49 | 0.49 | 0.49 | 0.49 | 0 | 0 |
| Fe₂O₃ | 0 | 1.77 | 1.77 | 1.86 | 1.87 | 1.87 | 1.77 | 1.77 | 1.95 |
| CuO | 0 | 0 | 0 | 0 | 0 | 0 | 0 | 0 | 0 |
| NiO | 0 | 0 | 0 | 0 | 0 | 0 | 0 | 0 | 0 |
| Co₃O₄ | 0 | 0.1 | 0.1 | 0.1 | 0.1 | 0.1 | 0.1 | 0.1 | 0.1 |
| Se | 0.0033 | 0.0018 | 0.0018 | 0.0032 | 0.0013 | 0.0019 | 0.0025 | 0.010 | 0.010 |
| TiO₂ | 0 | 0.6 | 0 | 0 | 0 | 0 | 0 | 0 | 0 |
| Cl | 0 | 0.2 | 0.2 | 0.2 | 0.2 | 0.2 | 0 | 0 | 0 |
| SO₃ | 0.1 | 0 | 0 | 0 | 0 | 0 | 0.1 | 0.1 | 0.1 |
| Total | 99.50 | 99.73 | 99.74 | 99.48 | 99.82 | 99.72 | 99.74 | 99.76 | 99.75 |
| amount | | | | | | | | | |

TABLE 17

| | Example | Example | Example | Example | Example |
|---|---|---|---|---|---|
| mol % | 79 | 80 | 81 | 82 | 83 |
| SiO₂ | 62.79 | 62.73 | 70.32 | 70.19 | 71.65 |
| B₂O₃ | 0 | 0 | 0 | 0 | 0 |
| Al₂O₃ | 7.81 | 7.8 | 1.07 | 1.07 | 1.11 |
| Na₂O | 12.21 | 12.29 | 12.31 | 12.28 | 12.59 |
| K₂O | 3.91 | 3.9 | 0.2 | 0.19 | 0.19 |
| CaO | 0 | 0 | 8.4 | 8.38 | 8.6 |
| MgO | 10.25 | 10.15 | 5.37 | 5.36 | 5.47 |
| ZrO₂ | 0.49 | 0.49 | 0 | 0 | 0 |
| Fe₂O₃ | 1.87 | 1.86 | 1.77 | 1.95 | 0 |
| CuO | 0 | 0 | 0 | 0 | 0 |
| NiO | 0 | 0 | 0 | 0 | 0 |
| Co₃O₄ | 0.1 | 0.1 | 0.1 | 0.1 | 0.01 |
| Se | 0.0017 | 0.0033 | 0.013 | 0.014 | 0.011 |
| TiO₂ | 0 | 0 | 0 | 0 | 0 |
| Cl | 0 | 0.2 | 0.2 | 0.19 | 0 |
| SO₃ | 0.1 | 0 | 0 | 0 | 0.1 |
| Total | 99.53 | 99.52 | 99.75 | 99.72 | 99.73 |
| amount | | | | | |

According to the present invention, it is possible to produce a colored glass for chemical strengthening and a colored chemical strengthened glass having smaller color tone change before and after chemical strengthening by suppressed metamerism, and having excellent mechanical strength.

The present invention can be used for decorations of an operating panel of an audiovisual apparatus, office automation apparatus, or the like, an opening/closing door, an operating button/knob of the same product, or the like, or a decorative panel disposed around a rectangular display surface of an image display panel of a digital photo frame, TV, or the like, and for a glass exterior member for an electronic device, and the like. It can also be used for an automobile interior member, a member of furniture or the like, a building material used outdoors or indoors, or the like.

What is claimed is:

1. A glass comprising a coloring component, having an absolute value of a difference Δa* between chromaticity a* of reflected light by a D65 light source and chromaticity a* of reflected light by an F2 light source in an L*a*b* color system expressed by a following expression (1) of 2.0 or less.
Δa*=a*value(D65 light source)−a*value(F2 light source) (1)

2. A glass comprising a coloring component, having both of an absolute value of a difference Δa* between chromaticity a* of reflected light by a D65 light source and chromaticity a* of reflected light by an F2 light source in an L*a*b* color system expressed by a following expression (1) and an absolute value of a difference Δb* between chromaticity b* of the reflected light by the D65 light source and chromaticity b* of the reflected light by the F2 light source in the L*a*b* color system expressed by a following expression (2), of 2.0 or less.
Δa*=a*value(D65 light source)−a*value(F2 light source) (1)
Δb*=b*value(D65 light source)−b*value(F2 light source) (2)

3. The glass according to claim 1, wherein L* in the L*a*b* color system is in a range of 20 to 85.

4. The glass according to claim 3, wherein L* in the L*a*b* color system is in a range of 20 to 60.

5. The glass according to claim 1, wherein the coloring component comprises at least one component selected from a group consisting of Fe₂O₃, CuO, V₂O₅ and Se with a total amount of 0.001% to 5% expressed in mole percentage based on oxides.

6. The glass according to claim 5, wherein the coloring component comprises Fe₂O₃ with an amount of 0.015% to 5%.

7. The glass according to claim 5, wherein the coloring component comprises CuO with an amount of 0.01% to 5%.

8. The glass according to claim 5, wherein the coloring component comprises V₂O₅ with an amount of 0.01% to 5%.

9. The glass according to claim 5, wherein the coloring component comprises Se with an amount of 0.001% to 5%.

10. The glass according to claim 1, wherein the glass comprises, in mole percentage based on following oxides, 55% to 80% of SiO₂, 0.25% to 16% of Al₂O₃, 0% to 12% of B₂O₃, 5% to 20% of Na₂O, 0% to 15% of K₂O, 0% to 15% of MgO, 0% to 15% of CaO, 0% to 25% of ΣRO (R represents Mg, Ca, Sr, Ba, Zn), 0% to 5% of Fe₂O₃, 0% to 5% of CuO, 0% to 5% of V₂O₅, 0% to 5% of Se, and 0.001% to 5% of Fe₂O₃+CuO+V₂O₅+Se.

11. The glass according to claim 1, wherein the glass is used as an exterior member.

12. A chemical strengthened glass comprising a coloring component, wherein an absolute value of a difference Δa* between chromaticity a* of reflected light by a D65 light source and chromaticity a* of reflected light by an F2 light source in an L*a*b* color system expressed by a following expression (1) is 2.0 or less, and a surface compressive stress layer is 5 μm to 70 μm in a depth direction from a surface.
Δa*=a*value(D65 light source)−a*value(F2 light source) (1)

13. A chemical strengthened glass comprising a coloring component, wherein both of an absolute value of a difference Δa* between chromaticity a* of reflected light by a D65 light source and chromaticity a* of reflected light by an F2 light source in an L*a*b* color system expressed by a following expression (1) and an absolute value of a difference Δb* between chromaticity b* of the reflected light by the D65 light source and chromaticity b* of the reflected light by the F2 light source in the L*a*b* color system expressed by a following expression (2), are 2.0 or less, and a surface compressive stress layer is 5 μm to 70 μm in a depth direction from a surface.
Δa*=a*value(D65 light source)−a*value(F2 light source) (1)
Δb*=b*value(D65 light source)−b*value(F2 light source) (2)

14. The chemical strengthened glass according to claim 12, wherein L* in the L*a*b* color system is in a range of 20 to 85.

15. The chemical strengthened glass according to claim 14, wherein L* in the L*a*b* color system is in a range of 20 to 60.

16. The chemical strengthened glass according to claim 12, comprising, as the coloring component, a total amount of at least one component selected from a group consisting of Fe₂O₃, CuO, V₂O₅ and Se of 0.001% to 5%, expressed in mole percentage based on oxides.

17. The chemical strengthened glass according to claim 16, wherein the coloring component comprises Fe₂O₃ with an amount of 0.015% to 5%.

18. The chemical strengthened glass according to claim 16, wherein the coloring component comprises CuO with an amount of 0.01% to 5%.

19. The chemical strengthened glass according to claim 16, wherein the coloring component comprises V₂O₅ with an amount of 0.01% to 5%.

20. The chemical strengthened glass according to claim 16, wherein the coloring component comprises Se with an amount of 0.001% to 5%.

21. The chemical strengthened glass according to claim 12, wherein the glass comprises, in mole percentage based on following oxides, 55% to 80% of SiO₂, 0.25% to 16% of Al₂O₃, 0% to 12% of B₂O₃, 5% to 20% of Na₂O, 0% to 15% of K₂O, 0% to 15% of MgO, 0% to 15% of CaO, 0% to 25% of ΣRO (R represents Mg, Ca, Sr, Ba, Zn), 0% to 5% of Fe₂O₃, 0% to 5% of CuO, 0% to 5% of V₂O₅, 0% to 5% of Se, and 0.001% to 5% of Fe₂O₃+CuO+V₂O₅+Se.

22. The chemical strengthened glass according to claim 12, wherein the glass has a surface compressive stress of 300 MPa to 1400 MPa.

23. The chemical strengthened glass according to claim 12, wherein the glass is used as an exterior member.
